(19) United States
(12) Patent Application Publication
(10) Pub. No.: US 2001/0014366 A1
(43) Pub. Date: Aug. 16, 2001

(54) Method of packaging perishable material

(75) Inventor: David Abraham Hammond, Raewick (GB)

Correspondence Address: JENKENS & GILCHRIST, A PROFESSIONAL CORPORATION, 1100 LOUISIANA, SUITE 1800, HOUSTON, TX, 77002-5214, US

(73) Assignee: Shetland Seafood Specialities Limited, Shetland Islands (GB)

(21) Appl. No.: 09/817,890

(22) Filed: Mar. 26, 2001

Related U.S. Application Data
(63) Continuation of application No. PCT/GB99/03275, filed on Oct. 1, 1999.

(30) Foreign Application Priority Data
Oct. 1, 1998 (GB) GB 9821225.1

(51) Int. Cl. A23L 3/00

(52) U.S. Cl. 426/401; 426/394

(57) ABSTRACT

A method of packaging a perishable material is disclosed, comprising sealing the heated material in a container and allowing the heated material to induce a pressure change in the container. The container then undergoes a volume change to induce a further temperature rise as a result of Boyle's law. The further temperature rise combats the viability of microorganisms in the material.

This invention relates to a method of packaging perishable material and of filling containers with perishable material.

Existing canning methods generally involve a cold fill process where the foodstuff or other perishable material to be canned is filled into the can before being heated to impart a measure of sterility to the foodstuff.

According to the present invention there is provided a method of filling a container with a material, the method comprising heating the material to above ambient temperature, placing the material in the container, and subsequently sealing the container and allowing the material to cool in the sealed container.

The material is preferably perishable, and may be a foodstuff.

Preferably, a head space is left between the top of the foodstuff in the filled container and the seal, typically so that steam or other vapour can be generated in the head space between the seal and the foodstuff in the container when the container is sealed.

Typically, the head space accounts for around 15% of the volume of the container after the seal has been applied.

The foodstuff is preferably heated at a temperature hot enough to produce steam or other vapour in the head space.

The container should preferably be oxygen impermeable. The container preferably has a movable wall such that the internal volume of the container can be varied by movement of the wall from one configuration to another. A suitable configuration of movable wall is a concave bottom for the container which can change its configuration from concave to convex upon the application of increased pressure within the container. The increase in volume occurring as a result of the movement of the wall is typically around 3-20% generally, and 8-10% preferably. Only minimal movement of the wall in the order of a few millimeters is necessary to achieve this, and volume changes outside these ranges will also work adequately.

As the pressure increases in the container, the temperature increases slightly in accordance with Boyle's law, but the pressure increase also moves the concave wall over centre to increase the volume dramatically as it passes the mid-point. The dramatic increase in volume reduces the pressure, and both of these changes in volume and pressure co-operate to reduce the rate of increase in the temperature at that instant. However, steam is still generated in the head space in the now fixed volume. This increases the temperature again in accordance with Boyle's law. The resultant temperature increase preferably raises the internal temperature within the container to around 110° C., and the temperature is preferably held in that range for around 45 seconds, or sufficiently long to kill viable bacteria and to sterilise to a certain extent the contents of the container. The container is then preferably plunged into an ice bath to condense the steam, and reduce the pressure in the head space to create a vacuum. The bottom of the container then resumes its original concave shape, reducing the head space once more to around 15%.

The filled container can then be chilled at 4° C. or below for at least 30 days.

An embodiment of the invention will now be described by way of example, and with reference to the accompanying drawings, in which:

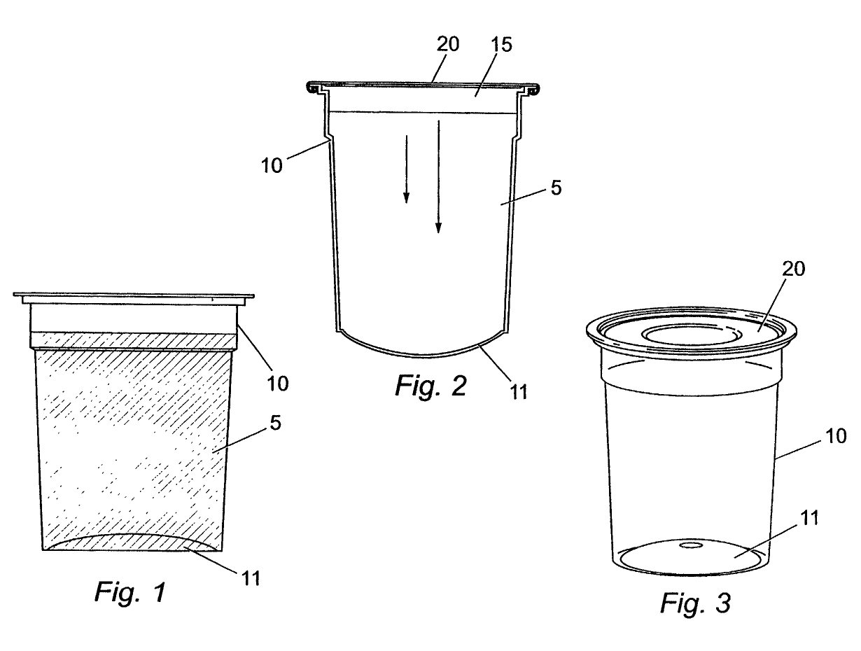

FIG. 1 is a side view of a container filled with a foodstuff prior to sealing;

FIG. 2 is a side view of the FIG. 1 container after sealing; and

FIG. 3 is a side view of the FIGS. 1 and 2 container after sealing and cooling of the foodstuff in the container.

Referring now to the drawings, a foodstuff such as fish or a similar such seafood is heated to around 100° C. and infilled into a container 10. The heating can conveniently be carried out in the open container. The container 10 has a typical volume of 500-530 cm³ when in the FIG. 1 configuration, and the foodstuff 5 is infilled into the container to leave approximately 15% of the volume of the container as free head space without foodstuff 5. An aluminium cap 20 is then sealed hermetically to the container 10, and the hot foodstuff 5 generates steam in the head space 15 between the seal 20 and the foodstuff 5.

The generation of steam in the head space 15 from the foodstuff 5 results in a pressure increase within the sealed container 10. This pressure increase increases the temperature in the container in accordance with Boyle's law, and induces movement of the concave bottom from its initial concave shape shown in FIG. 1 to its convex shape shown in FIG. 2. The configuration change from concave to convex of the bottom 11 typically takes place at a predetermined pressure within the container 10, and occurs suddenly as the concave wall gradually moves over centre. The sudden increase in volume and concurrent decrease in pressure causes a momentary decrease in the rate of rise in temperature according to Boyle's Law. However, the high temperature continues to cause steam generation which increases the pressure in the expanded FIG. 2 container, thereby increasing the temperature in accordance with Boyle's law since the volume remains constant after the configurational change of the wall. The temperature within the container is thereby raised to around 110° C., at which it remains for around 45 seconds, during which time the high temperature combats the viability of any harmful microorganisms.

The sealed container in its expanded configuration shown in FIG. 2 is then plunged into an ice bath at around 4° C. to condense the steam and create a vacuum in the head space 15, causing the container to revert to its FIG. 3 configuration with the head space 15 making up around 15% of the volume of the container 10.

The sealed container 10 can then be stored at 4° C. suffering no loss in quality of the foodstuff 5 for at least 30 days in most cases, and has been tested for biological safety at far longer periods, eg 60d.

Certain embodiments of the container can optionally be slightly oxygen permeable, since this can combat the growth of certain harmful and/or undesirable bacteria such as Clostridium Botulinum and other anaerobic species. The preferred material of construction of the container is polypropylene which has an oxygen transmission rate of approximately 0.0019 ml/24 hr/mm thickness, so that one such embodiment of the container used allows permeation of 0.00237 ml/24 hr, although specific oxygen transmission rates of twice or three times that amount can be used without adversely affecting the quality of the material in the container.

Modifications and improvements can be incorporated without departing from the scope of the invention.

1. A method of filling a container with a material, the method comprising heating the material to above ambient temperature, placing the material in the container, and subsequently sealing the container and allowing the material to cool in the sealed container.

2. A method according to claim 1, wherein the material is heated after being placed in the container.

3. A method according to claim 1 or claim 2, wherein the material is perishable.

4. A method according to any preceding claim, wherein the material is a foodstuff.

5. A method according to any preceding claim, wherein a space is left between the top of the material in the filled container and the seal.

6. A method according to claim 5, wherein steam or other vapour is generated in the space when the container is sealed.

7. A method according to claim 5 or claim 6, wherein the space accounts for at least 5% of the volume of the container after the seal has been applied.

8. A method according to any one of claims 5, 6 and 7, wherein the space accounts for 10-20% of the volume of the container after the seal has been applied.

9. A method according to any one of claims 5-8, wherein the space accounts for approximately 15% of the volume of the container after the seal has been applied.

10. A method according to any preceding claim, wherein the material is heated to a temperature hot enough to produce steam or other vapour from the material.

11. A method according to any preceding claim, wherein the container is oxygen impermeable.

12. A method according to any preceding claim, wherein the container has a movable wall such that the volume of the container can be varied by movement of the wall from one configuration to another.

13. A method according to claim 12, wherein the movable wall is a concave portion of the container which can change its configuration from concave to convex upon the application of increased pressure within the container.

14. A method according to claim 12 or claim 13, wherein the movable wall forms at least a portion of the base of the container.

15. A method according to any preceding claim, further including the step of increasing the volume of the container.

16. A method according to claim 15, wherein the volume increases by 5-20%.

17. A method according to claim 15 or claim 16, wherein the volume increases by 8-10%.

18. A method according to claim 15, 16 or 17, wherein the volume increases only once.

19. A method according to claim 15, 16 or 17, wherein the volume increases more than once.

20. A method according to any preceding claim, further comprising the step of cooling the sealed container to condense vapour in the container.

21. A method according to any preceding claim, further including increasing the temperature within the container to above 100° C.

22. A method according to any preceding claim, further including increasing the temperature within the container to at least 110° C.

23. A method according to any preceding claim, wherein the temperature is raised above ambient temperature for at least 30-45 seconds.

24. A method according to any preceding claim, further including the step of reducing the volume of the container to it's starting volume.
